(19) United States
(12) Patent Application Publication
(10) Pub. No.: US 2015/0378224 A1
(43) Pub. Date: Dec. 31, 2015

(54) DISPLAY PANEL AND METHOD OF MANUFACTURING THE SAME

(71) Applicant: SAMSUNG DISPLAY CO., LTD., YONGIN-CITY (KR)

(72) Inventors: Koichi SUGITANI, Gyeonggi-do (KR); Hoon KANG, Gyeonggi-do (KR); Chul-Won PARK, Gyeonggi-do (KR); Yang-Ho JUNG, Seoul (KR); Jin-Ho JU, Seoul (KR)

(21) Appl. No.: 14/582,490

(22) Filed: Dec. 24, 2014

(30) Foreign Application Priority Data
Jun. 26, 2014 (KR) 10-2014-0079257

(51) Int. Cl. G02F 1/1362; G02F 1/1333; G02F 1/1335; G02F 1/1368

(52) U.S. Cl. CPC G02F 1/136209; G02F 1/1368; G02F 1/136286; G02F 1/133345; G02F 1/133516; G02F 2001/136222; G02F 2001/136295

(57) ABSTRACT

A display panel is provided. A plurality of thin-film transistors is disposed on a substrate. A plurality of data lines is disposed on the substrate. Each data line is connected to each thin-film transistor. A plurality of color filters is disposed on the substrate. Each color filter is disposed between two adjacent data lines. A plurality of black matrices is disposed on the substrate. Each black matrix overlaps each data line. A liquid crystal layer is disposed on the plurality of color filters. The liquid crystal layer includes a flat area having a substantially flat surface and a stepped area having a stepped height. The stepped area is adjacent to an edge of the flat area.

This application claims priority under 35 U.S.C. §119 to Korean Patent Application No. 10-2014-0079257, filed on Jun. 26, 2014, in the Korean Intellectual Property Office, the disclosure of which is incorporated by reference herein in its entirety.

### TECHNICAL FIELD

The present invention relates to a display panel and a method of manufacturing the same.

### DISCUSSION OF RELATED ART

Liquid crystal displays display image using liquid crystal molecules. The orientation of such liquid crystal molecules may be controlled by an electric field to control polarization of incident light from a source light. The liquid crystal molecules may be held in a microcavity structure.

### SUMMARY

According to an exemplary embodiment of the inventive concept, a display panel is provided. A plurality of thin-film transistors is disposed on a substrate. A plurality of data lines is disposed on the substrate. Each data line of the plurality of data lines is connected to each thin-film transistor of the plurality of thin-film transistors. A plurality of color filters is disposed on the substrate. Each color filter of the plurality of color filters is disposed between two adjacent data lines of the plurality of data lines. A plurality of black matrices is disposed on the substrate. Each black matrix of the plurality of black matrices overlaps each data line of the plurality of data lines. A liquid crystal layer is disposed on the plurality of color filters. The liquid crystal layer includes a flat area having a substantially flat surface and a stepped area having a stepped height. The stepped area is adjacent to an edge of the flat area.

According to an exemplary embodiment of the inventive concept, a method of manufacturing a display panel is provided. A plurality of thin-film transistors is formed on a substrate. A plurality of data lines is formed on the substrate. Each data line of the plurality of data lines is connected to each thin-film transistor of the plurality of thin-film transistors. A plurality of color filters is formed on the substrate. Each color filter of the plurality of color filters is disposed between two adjacent data lines of the plurality of data lines. A plurality of black matrices is on the substrate. Each black matrix of the plurality of black matrices is disposed between two adjacent color filters of the plurality of color filters. Each black matrix of the plurality of black matrices overlaps each data line of the plurality of data lines. A photoresist composition is coated on the plurality of color filters and the plurality of black matrices to form a sacrificial layer. Light is provided to the sacrificial layer through a mask. The mask includes a transparent part disposed on the plurality of data lines, a blocking part disposed on the plurality of color filters, and a slit part disposed between the transparent part and the blocking part. An intensity of light provided through the slit part is smaller than an intensity of light provided through the transparent part. Hard-baking of the sacrificial layer is performed to form a sacrificial pattern. The sacrificial pattern includes a flat area having a substantially flat surface and a stepped area having a stepped height adjacent to an edge of the flat area.

According to an exemplary embodiment of the inventive concept, a method of manufacturing a display panel is provided. A first color filter and a second color filter are formed on a substrate. A first electrode and a second electrode are formed on the first color filter and the second color filter, respectively. A black matrix is formed between the first color filter and the second color filter. A sacrificial layer is formed on the first color filter, the second color filter and the black matrix. The sacrificial layer is patterned to form a preliminary first sacrificial pattern on the first color filter and a preliminary second sacrificial pattern on the second color filter by removing a portion of the sacrificial layer disposed between the first color filter and the second color filter. The preliminary first sacrificial pattern includes a first flat region and a first stepped region. The preliminary second sacrificial pattern includes a second flat region and a second stepped region. The first stepped region and the second stepped region face each other across the black matrix disposed between the first stepped region and the second stepped region. The first flat region and the second flat region include substantially flat surface. The preliminary first sacrificial pattern and the preliminary second sacrificial pattern are baked to form a first sacrificial pattern and a second sacrificial pattern.

### BRIEF DESCRIPTION OF THE DRAWINGS

These and other features of the present invention will become more apparent by describing in detail exemplary embodiments thereof with reference to the accompanying drawings of which:

FIG. 1 is a plan view illustrating a display panel in accordance with an exemplary embodiment of the present invention;

FIG. 2 is a plan view illustrating a first pixel of the display panel of FIG. 1;

FIG. 3 is a cross-sectional view taken along line I-I′ of FIG. 1; and

FIGS. 4A to 4I are cross-sectional views taken along line I-I′ of FIG. 1 illustrating a method of manufacturing a display panel in accordance with an exemplary embodiment of the present invention.

### DETAILED DESCRIPTION OF EXEMPLARY EMBODIMENTS

Exemplary embodiments of the present invention will be described below in detail with reference to the accompanying drawings. However, the present invention may be embodied in different forms and should not be construed as limited to the embodiments set forth herein. In the drawings, the thickness of layers and regions may be exaggerated for clarity. It will also be understood that when an element is referred to as being “on” another element or substrate, it may be directly on the other element or substrate, or intervening layers may also be present. It will also be understood that when an element is referred to as being “coupled to” or “connected to” another element, it may be directly coupled to or connected to the other element, or intervening elements may also be present. Like reference numerals may refer to the like elements throughout the specification and drawings.

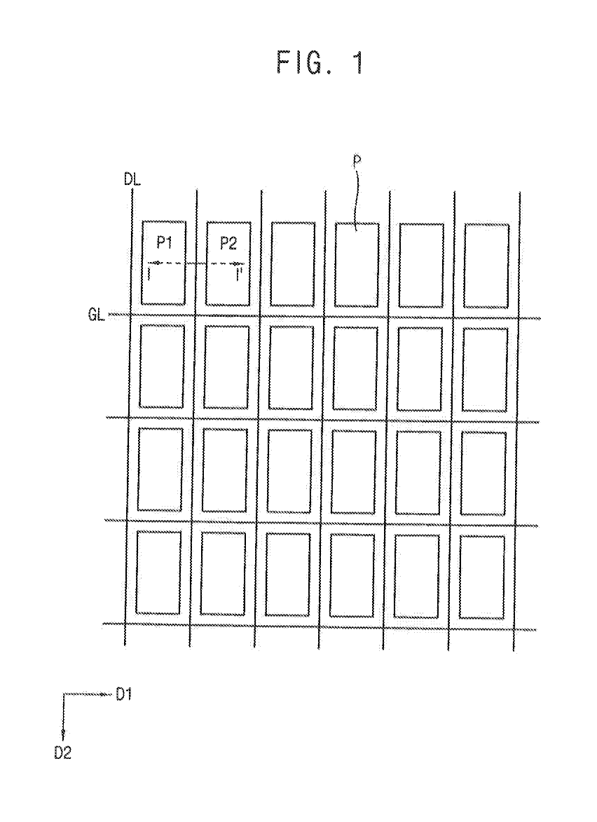

FIG. 1 is a plan view illustrating a display panel in accordance with an exemplary embodiment of the present invention.

Referring to FIG. 1, a display panel includes a plurality of gate lines GL, a plurality of data lines DL and a plurality of pixels.

The gate lines GL extends in a first direction D1. The data lines DL extends in a second direction substantially crossing the first direction D1. Alternatively, the gate lines GL may extend in the second direction D2 and the data lines DL may extend in the first direction D1.

The pixels P are arranged in a matrix shape. The pixels P may be disposed in areas defined by the gate lines GL and the data lines DL.

Each pixel P may be connected to a corresponding gate line GL and a corresponding data line DL adjacent to the pixel.

Each pixel P has a rectangle shape extending in the second direction D2. Alternatively, the pixel may have a V-shape, a Z-shape or the like.

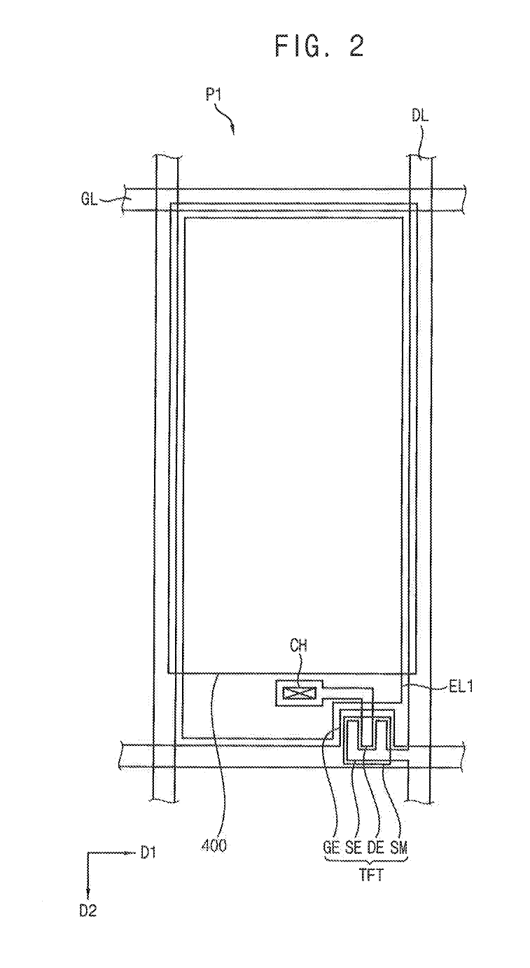

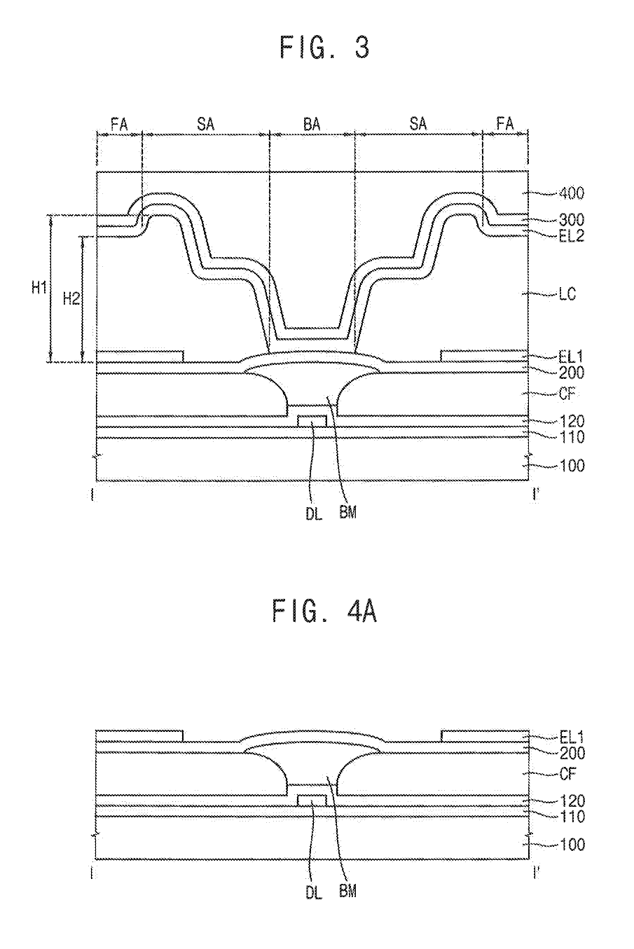

FIG. 2 is a plan view illustrating a first pixel P1 of the display panel of FIG. 1. FIG. 3 is a cross-sectional view taken along line I-I′ of FIG. 1.

Referring to FIGS. 1 to 3, the display panel includes a substrate 100, thin film transistors TFT, a gate insulating layer 110, a data insulating layer 120, a black matrix BM, a color filter CF, a first insulating layer 200, a first electrode EL1, a liquid crystal layer LC, a second electrode EL2, a second insulating layer 300, and a roof layer 400.

The substrate 100 may be a transparent insulating substrate. The transparent insulating substrate may be, but is not limited to, a glass substrate, a plastic substrate or the like. The substrate 100 may include a plurality of pixel areas for displaying an image. The pixel areas may be disposed in a matrix shape having a plurality of rows and a plurality of columns.

Each pixel may further include a switching element. For example, the switching element may be a thin film transistor TFT. The switching element may be connected to the gate line GL and the data line DL adjacent to the switching element. The switching element may be disposed at a crossing area of the gate line GL and the data line DL.

A gate pattern may include a gate electrode GE and the gate line GL. The gate pattern may be disposed on the substrate 100. The gate line GL is electrically connected to the gate electrode GE.

The gate insulating layer 110 may be disposed on the substrate 100 to cover the gate pattern and may insulate the gate pattern.

A semiconductor pattern SM may be disposed on the gate insulating layer 110. The semiconductor pattern SM may overlap the gate electrode GE.

A data pattern may include the data line DL, a source electrode SE and a drain electrode DE. The data pattern may be disposed on the semiconductor pattern SM, which is formed on the gate insulating layer 110. The source electrode SE may overlap the semiconductor pattern SM. The source electrode SE may be electrically connected to the data line DL.

The drain electrode DE may be spaced apart from the source electrode SE on the semiconductor pattern SM. The semiconductor pattern SM may have a conductive channel between the source electrode SE and the drain electrode DE.

The TFT may include the gate electrode GE, the source electrode SE, the drain electrode DE and the semiconductor pattern SM.

The data insulating layer 120 is disposed on the gate insulating layer 110. The data insulating layer 120 may serve to insulate the data pattern.

The gate insulating layer 110 and the data insulating layer 120 may include an organic insulating material or an inorganic insulating material. For example, the gate insulating layer 110 and the data insulating layer 120 may include silicon oxide (SiO_{X}) or silicon nitiride (SiN_{X}).

A plurality of color filters CF and a plurality of black matrices BM are disposed on the data insulating layer 120.

The color filters CF may be disposed between adjacent data lines DL. The color of light may be changed by the color filters CF and the light may penetrate the liquid crystal layer LC.

Each color filter CF may correspond to one pixel area. For example, the color filters CF may include a red color filter, a green color filter and a blue color filter. The color filters CF, which are adjacent to each other, may have different colors from each other. For example, the color filters CF may be spaced apart from a border between pixel areas adjacent to each other.

The plurality of color filters CF may be disposed in an island shape. Alternatively, the color filters CF adjacent to each other may partially overlap each other on a border between pixel areas adjacent to each other.

The display panel may include signal lines and black matrices BM. The signal lines may be connected to the TFT. The black matrices BM may overlap the signal lines and may block light.

The black matrices BM are disposed on a boarder between the pixel areas adjacent to each other. For example, the black matrices BM are disposed between adjacent color filters CF.

The black matrices BM may be disposed on an area under which the gate line GL, the data line DL and the switching element are disposed. The black matrices BM may be overlapped with a plurality of the gate lines extending to the first direction D1 and a plurality of data lines extended in the second direction D2 crossing the first direction D1, to thereby block a light. For example, the black matrices BM may be disposed on a non-display area.

For example, the black matrices BM may include a photosensitive organic material including a pigment, such as carbon black or the like.

A first insulating layer 200 is disposed on the color filters CF.

The first insulating layer 200 may be disposed on the whole surface of the substrate 100. For example, the first insulating layer 200 covers the color filters CF and the black matrices BM.

The first insulating layer 200 may include an organic insulating material or an inorganic insulating material. For example, the first insulating layer 200 may include silicon oxide (SiO_{X}) or silicon nitiride (SiN_{X}).

The first electrode EL1 may be disposed on a pixel area. The first electrode EL1 is disposed on the first insulating layer 200 and the color filter CF. The first electrode EL1 may be electrically connected to the TFT. A grayscale voltage may be applied to the first electrode EL1 through the TFT.

For example, the first electrode EL1 may include a transparent conductive material, such as indium tin oxide (ITO), indium zinc oxide (IZO) and aluminum zinc oxide (AZO).

For example, the first electrode EL1 may have a slit pattern.

The display panel may include an alignment layer to align a liquid crystal layer LC. The alignment layer may be disposed between the liquid crystal layer LC and the first insulating layer 200. The alignment layer may also be disposed between the liquid crystal layer LC and the second insulating layer 300. For example, the alignment layer may be disposed in a tunnel-shaped cavity TSC.

The liquid crystal layer LC is disposed between the first insulating layer 200 and the second insulating layer 300.

The liquid crystal layer LC is disposed on the color filters CF.

The liquid crystal layer includes a flat area FA and a steeped area SA. The flat area FA may have a flat surface. The stepped area may have a stepped height adjacent to an edge of the flat area.

The stepped area SA is adjacent to the black matrices BM.

The stepped area SA includes a convex portion adjacent to the flat area FA. A height H1 of the convex portion is greater than a height H2 of the flat area. The height of the convex portion and the flat area is measured from the first insulating layer 200.

A height difference H1-H2 between the convex portion and the flat area may be equal to or less than about 0.35 μm. When the height difference H1-H2 is more than about 0.35 μm, a display panel corresponding to the stepped area SA may be dark so that an aperture ratio of a pixel area is decreased.

For example, the liquid crystal layer LC may include a liquid crystal. An alignment of the liquid crystal molecule may be controlled by an electric field applied between the first electrode EL1 and the second electrode EL2. Therefore, a light transmittance of the pixel may be controlled.

The second electrode EL2 is disposed on the black matrices BM and the liquid crystal layer LC. For example, the second electrode EL2 may include a transparent conductive material such as indium tin oxide (ITO) and indium zinc oxide (IZO).

The second insulating layer 300 is disposed on the second electrode EL2. The second insulating layer 300 may include an organic insulating material or an inorganic insulating material. For example, the second insulating layer 300 may include silicon oxide (SiO_{X}) or silicon nitiride (SiN_{X}).

The roof layer 400 is disposed on the second insulating layer 300.

For example, the roof layer 400 may include an organic material. Although it is not illustrated in the figures, a developer injecting hole may be formed on the roof layer 400 to form the liquid crystal layer LC by injecting liquid crystal molecules through the developer injecting hole. The roof layer 400 may be hardened by heat.

Although it is not illustrated in the figures, an encapsulating layer may be disposed on the roof layer 400 so that the encapsulating layer may cover the developer injecting hole to prevent the liquid crystal from leaking through the developer injecting hole.

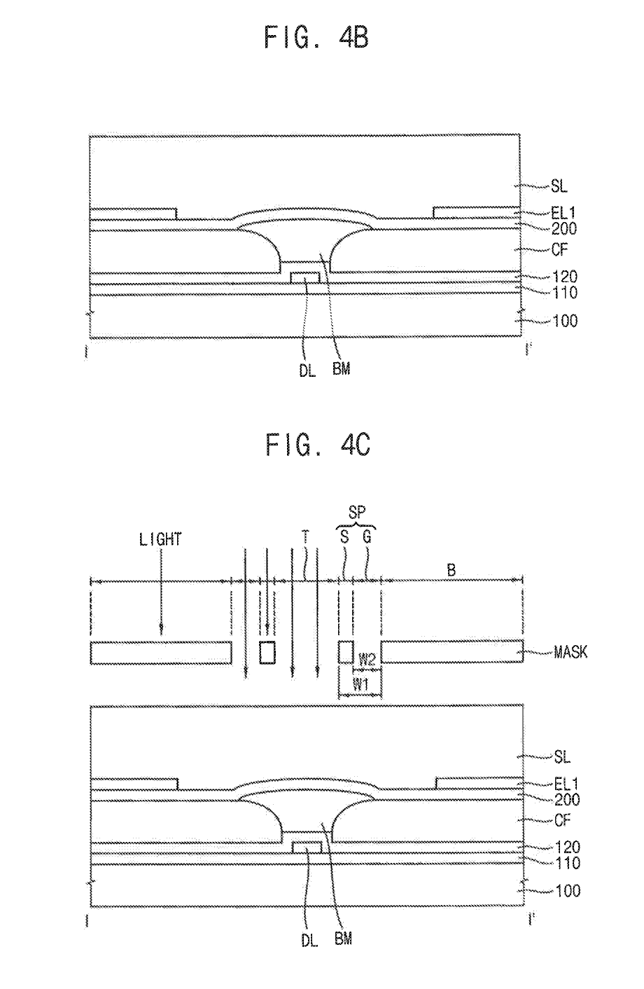

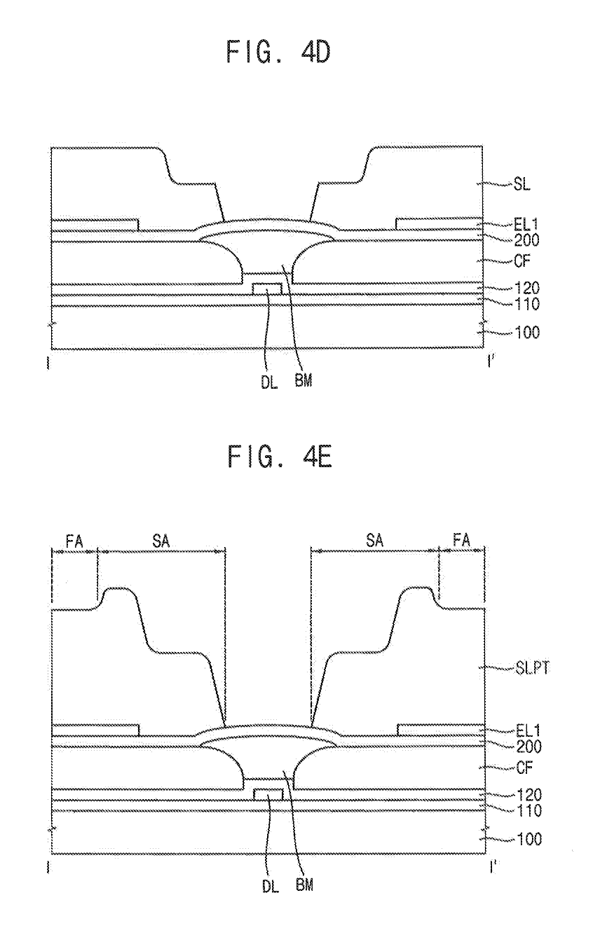

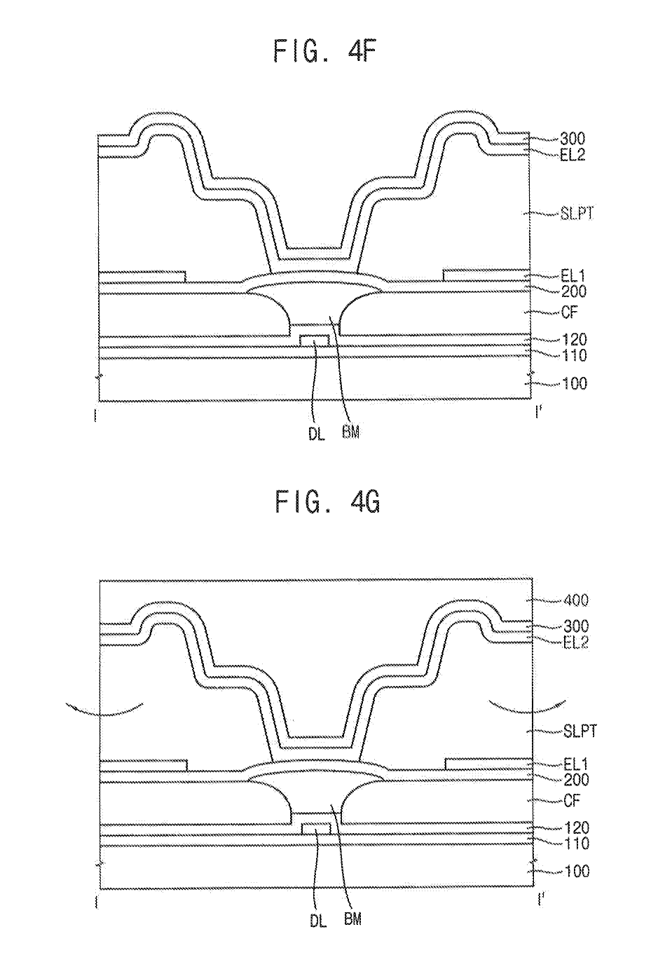

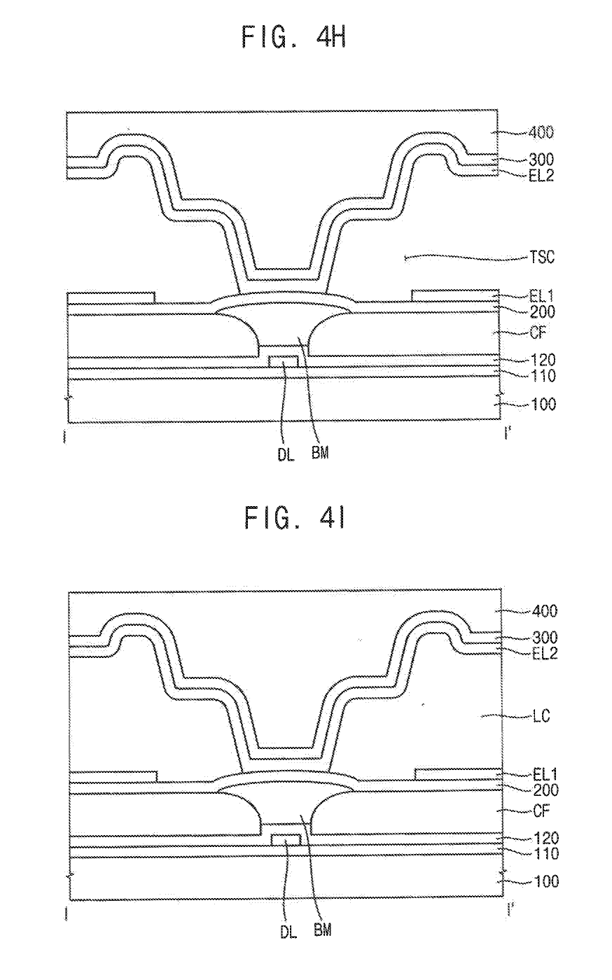

Hereinafter, it will be described a method of forming the stepped area SA of FIG. 3 with reference to FIGS. 1 to 4I. FIGS. 4A to 4I are cross-sectional views taken along line I-I′ of FIG. 1 illustrating a method of manufacturing a display panel in accordance with an exemplary embodiment of the present invention.

Referring to FIGS. 1 to 4A, a plurality of color filters CF and a plurality of black matrices BM are formed on a substrate 100. The substrate 100 includes a gate insulating layer 110, a data line DL and a data insulating layer 120.

A gate pattern including a gate electrode GE and a gate line GL may be formed on the substrate 100. To form the gate pattern, a first conductive layer may be formed on the substrate 100 and may be patterned by a photolithography process.

The gate insulating layer 110 may be formed on the substrate 100 to cover the gate pattern. The gate insulating layer 110 may insulate the gate pattern.

A semiconductor pattern SM may be formed on the gate insulating layer 110. The semiconductor pattern SM may overlap with the gate electrode GE.

A data pattern including a data line DL, a source electrode SE and a drain electrode DE may be formed on the gate insulating layer 110 on which the semiconductor pattern SM is formed. To form a data pattern, a second conductive layer may be formed on the gate insulating layer 110 and may be patterned by a photolithography process.

The drain electrode DE may be spaced apart from the source electrode SE on the semiconductor pattern SM. The semiconductor pattern SM may have a conductive channel between the source electrode SE and the drain electrode DE.

The TFT may include the gate electrode GE, the source electrode SE, the drain electrode DE and the semiconductor pattern SM.

The data insulating layer 120 is formed on the gate insulating layer 110 on which the data pattern is formed.

The color filters CF are formed on the data insulating layer 120. The color filters CF may be disposed between adjacent data lines DL.

The black matrices BM are formed on a border between two neighboring pixel areas. For example, the black matrices BM may be disposed between two neighboring color filters CF. The black matrices BM may be disposed on an area under which the gate line GL, the data line DL and the switching element are disposed. For example, the black matrices BM may include a photosensitive organic material including a pigment, such as carbon black or the like.

Referring to FIGS. 1 to 4B, a photoresist is coated on the color filters CF and the black matrices BM to form a sacrificial layer SL.

The sacrificial layer SL may be partially removed to form a space of a tunnel-shaped cavity. For example, the sacrificial layer may be formed at a position where the liquid crystal layer LC is formed. The sacrificial layer SL may determine a width and height of the tunnel-shaped cavity.

The sacrificial layer SL may be formed by coating the photoresist composition on the resulting structure of FIG. 4A. The photoresist composition may include a positive photoresist. The positive photoreisist may be an organic material including, such as, a siloxane resin, a novolak resin or the like.

The sacrificial layer SL may be formed by deposition and ashing processes or by deposition and polishing processes. Alternatively, the sacrificial layer may be formed by an inkjet process, a spin-coating process or the like.

The sacrificial layer SL may be soft-baked prior to light exposure.

For example, the sacrificial layer SL may be soft-baked within a temperature range of about 120° C. to about 130° C. When the sacrificial layer SL is soft-baked with a temperature less than about 120° C., the flat area FA of the sacrificial layer SL is decreased so that an aperture ratio is reduced. When the sacrificial layer SL is soft-baked with a temperature more than about 130° C., the convex portion of the stepped area SA of the sacrificial layer SL is increased so that an aperture ratio is reduced.

Referring to FIGS. 1 to 4E, the sacrificial layer SL is exposed and developed by using a mask MASK. The sacrificial layer SL is hard-baked, thus releasing a remaining gas in the sacrificial layer SL. For example, the sacrificial layer SL may be hard-baked within a temperature range of about 130° C. to about 150° C. Therefore, the sacrificial pattern SLPT may be formed, and the sacrificial pattern SLPT includes the flat area FA and the stepped area SA.

The mask MASK may include a transparent part T, a blocking part B and a slit part SP.

Light may be transmitted to the sacrificial layer disposed on the data lines DL through the transparent part T of the mask MASK. The blocking part B may block light incident thereon. The slit part SP may reduce light provided on the sacrificial layer disposed on the black matrices BM. The superposition of the light provided through the slit part SP and the transparent part T may generate a pattern of light absorbed by the sacrificial layer SL. The pattern of light may causes a chemical change that allows some of the sacrificial layer SL to be removed by a developing process. The sacrificial layer may a stepped structure after the developing process.

The slit part SP includes a slit S and a gap G. Light incident on the slit S is reflected. Light is transmitted through the gap G penetrates, and the transmitted light is incident on the sacrificial layer SL as shown in FIG. 4C.

An intensity of light provided through the gap G may be smaller than an intensity of light provided through the transparent part T.

For example, a width W2 of the gap G may be about 50% to about 80% of a width W2 of the slit part SP.

When the width W2 of the gap G is less than about 50% or more than about 80% of the width W2 of the slit part SP, the height difference H1-H2 between the flat area FA and the convex portion of the stepped area SA may be increased so that an aperture ratio may be reduced.

For example, the width W2 of the gap may be within a range of about 1.3 μm to about 2.1 μm. In this case, the width W1 of the slit part may be within a range of about 2.6 μm to about 4.2 μm.

An exposed portion of the sacrificial layer SL may be partially removed by using a developer as shown in FIG. 4D.

The developer may include an alkali solution. For example, the developer may include about 90% or more of water and 10% or less of alkali component. The developer only removes the sacrificial layer. For example, the developer may include about 2.38% of tetramethylammonium hydroxide (TMAH) or about 1% of potassium hydroxide (KOH). The removal of the sacrificial layer by the developer may be performed at about 23° C. to about 26° C.

TABLE 1

| | Width | Width | | | | |
|---|---|---|---|---|---|---|
| | of the | of the | Ratio of | Height difference | | |
| | gap | slit part | widths | (a − b)(μm) | | |
| | (W1) | (W2) | (W1/W2*100) | 258 | 539 | 1571 |
| | (μm) | (μm) | (%) | mJ | mJ | mJ |
| Exemplary | 2.1 | 3 | 70.0 | 0.417 | 0.346 | 0.207 |
| embodiment 1 | | | | | | |
| Exemplary | 1.9 | 3 | 63.3 | 0.340 | 0.251 | 0.144 |
| embodiment 2 | | | | | | |
| Exemplary | 1.7 | 3 | 56.7 | 0.301 | 0.269 | 0.144 |
| embodiment 3 | | | | | | |
| Exemplary | 1.5 | 3 | 50.0 | 0.290 | 0.486 | 0.182 |
| embodiment 4 | | | | | | |
| Exemplary | 1.3 | 2.6 | 50.0 | 0.355 | 0.321 | 0.142 |
| embodiment 5 | | | | | | |
| Comparative | 1.3 | 3 | 43.3 | 0.384 | 0.510 | 0.219 |
| embodiment 1 | | | | | | |
| Comparative | 1.1 | 3 | 36.7 | 0.454 | 0.493 | 0.253 |
| embodiment 2 | | | | | | |
| Comparative | 0.9 | 3 | 30.0 | 0.505 | 0.517 | 0.242 |
| embodiment 3 | | | | | | |
| Comparative | — | — | — | 0.431 | 0.476 | 0.277 |
| embodiment 4 | | | | | | |

Table 1 shows a height difference between the flat area FA and the convex portion of the stepped area SA of the sacrificial pattern SLPT in various sizes of the widths W1 and W2 as shown in FIG. 4C.

In accordance with exemplary embodiments 1 to 5 of the table 1, a width of the slit S and a width of the gap G are controlled so that the width W1 of the gap G is about 50% to about 80% of the width W2 of the slit part SP. And then, a height difference between the convex portion of the stepped area SA and the flat area FA is measured.

In accordance with comparative embodiments 1 to 3 of the table 1, the width of the slit S and a width of the gap G are controlled so that the width W1 of the gap G is less than about 50% or more that about 80% of the width W2 of the slit part SP. A height difference between the convex portion of the stepped area SA and the flat area FA is measured. In addition, in accordance with comparative embodiments 4 of the table 1, the slit part PG is not formed on the mask MASK so that the stepped area SA is not formed on the sacrificial layer SL. And a height difference between the convex portion of the stepped area SA and the flat area FA is measured.

Referring to Table 1, when the width W1 of the gap G is about 50% to about 80% of the width W2 of the slit part SP, a height difference between the convex portion of the stepped area SA and the flat area FA is smaller than the comparative embodiment 4. However, when the width (W1) of the gap G is less than about 50% or more than about 80% of the width (W2) of the slit part SP, a height difference between the convex portion of the stepped area SA and the flat area FA is equal to or greater than the comparative embodiment 4.

Referring to FIGS. 1 to 4F, the second electrode EL2 is formed on the sacrificial pattern SLPT, the second insulating layer 300 is formed on the second electrode EL2.

The second electrode EL2 is formed on the black matrices BM and the sacrificial pattern SLPT. For example, the second electrode EL2 may include a transparent conductive material such as indium tin oxide (ITO) and indium zinc oxide (IZO).

The second insulating layer 300 is disposed on the second electrode EL2. The second insulating layer 300 may include an organic insulating material or an inorganic insulating material. For example, the second insulating layer 300 may include silicon oxide (SiO_{X}) or silicon nitiride (SiN_{X}).

Referring to FIGS. 1 to 4H, the roof layer 400 is formed on the second insulating layer 300. And then, the sacrificial pattern SLPT is removed by using the developer.

Although it is not illustrated in the figures, before removing the sacrificial pattern SLPT, a developer injecting hole may be formed on the sacrificial layer.

A photoresist composition may be coated on the second insulating layer 300, which is formed on the second electrode EL2. The photoresist composition need not be formed on a position corresponding to the developer injecting hole that is used as a pathway for removing the sacrificial pattern SLPT. Therefore, the photoresist composition may expose a portion of the second insulation layer between pixel areas adjacent to each other.

The photoresist composition and the sacrificial pattern SLPT may be exposed to a light. The photoresist composition including a negative photoresist is hardened by the light exposure.

The second electrode EL2 and the second insulation layer 300 are transparent, thereby transmitting the light to the sacrificial pattern SLPT. Thus, the sacrificial pattern SLPT including a positive photoresist may be dissolved and transformed by the light exposure, and may be removed by a developing process. The intensity of light used for the light exposure may be in a range from about 300 mJ to about 3 J. The wavelength of the light may be about 365 nm.

The photoresist composition including the negative photoresist may be hardened, and then the exposed portion of the second insulating layer 300 may be partially removed by an etching process. Thus, the developer injecting hole may be formed. The photoresist composition may function as a mask, and the partially exposed portion of the second insulation layer may be etched to form the developer injecting hole.

A developer may be injected to the sacrificial pattern SLPT through the developer injecting hole. The developer eliminates the sacrificial pattern SLPT through the developer injecting hole. The sacrificial pattern SLPT may be removed by the developer because the sacrificial pattern SLPT has been transformed by the light exposure. A tunnel-shaped cavity TSC is formed by removing the sacrificial pattern SLPT by the developer. The tunnel-shaped cavity TSC is formed at a space where the sacrificial pattern SLPT is removed.

The developer may include an alkali solution. For example, the developer may include about 90% or more of water and about 10% or less of alkali component. The developer only removes the sacrificial pattern SLPT. For example, the developer may include about 2.38% of tetramethylammonium hydroxide (TMAH) or about 1% of potassium hydroxide (KOH).

The removal of the sacrificial pattern SLPT by the developer may be performed at about 23° C. to about 26° C. The removal of the sacrificial pattern SLPT may be accelerated by increasing the processing temperature. For example, the sacrificial layer may be removed by the developer at about 23° C. to about 80° C.

Referring to FIGS. 1 to 4I, the liquid crystal is injected into the tunnel-shaped cavity TSC, thus forming the liquid crystal layer LC.

The liquid crystal is provided as a fluid. The liquid crystal may flow into the tunnel-shaped cavity TSC by capillary action. For example, the liquid crystal may be provided into the tunnel-shaped cavity TSC through a developer injecting hole.

The liquid crystal may be provided into the tunnel-shaped cavity TSC by using an inkjet apparatus having a micropipette. Alternatively, the liquid crystal may be provided into the tunnel-shaped cavity TSC by using a vacuum injection apparatus. When using the vacuum injection apparatus, the developer injecting hole may be immersed in the chamber including a liquid crystal. When the pressure of the chamber decreases, the liquid crystal may be drawn into the tunnel-shaped cavity TSC by capillary action.

Although it is not illustrated in the figures, an encapsulating layer may be disposed on the roof layer 400 so that the encapsulating layer may cover the developer injecting hole to prevent the liquid crystal from leaking out from the tunnel-shaped cavity TSC.

According to an exemplary embodiment of the present invention, a display panel and a method of manufacturing the display panel may be used for a liquid crystal display panel including one base substrate and a liquid crystal display apparatus having the same.

While the present invention has been shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. A display panel comprising:
a substrate;
a plurality of thin-film transistors disposed on the substrate;
a plurality of data lines disposed on the substrate, wherein each data line of the plurality of data lines is connected to each thin-film transistor of the plurality of thin-film transistors;
a plurality of color filters disposed on the substrate, wherein each color filter of the plurality of color filters is disposed between two adjacent data lines of the plurality of data lines;
a plurality of black matrices disposed on the substrate, wherein each black matrix of the plurality of black matrices overlaps each data line of the plurality of data lines; and
a liquid crystal layer disposed on the plurality of color filters, wherein the liquid crystal layer comprises a flat area having a substantially flat surface and a stepped area having a stepped height, wherein the stepped area is adjacent to an edge of the flat area.

2. The display panel of claim 1, wherein the stepped area is adjacent to each black matrix of the plurality of black matrices.

3. The display panel of claim 1, wherein the stepped area comprises a convex portion adjacent to the edge of the flat area, and a height of the convex portion is greater than a height of the flat area.

4. The display panel of claim 1, further comprising:
a first electrode disposed on the plurality of color filters; and
a second electrode disposed on the liquid crystal layer.

5. The display panel of claim 4, further comprising:
an insulating layer disposed on the second electrode.

6. The display panel of claim 5, further comprising:
a roof layer disposed on the insulating layer.

7. A method of manufacturing a display panel comprising:
forming a plurality of thin-film transistors on a substrate;
forming a plurality of data lines on the substrate, wherein each data line of the plurality of data lines is connected to each thin-film transistor of the plurality of thin-film transistors;
forming a plurality of color filters on the substrate, wherein each color filter of the plurality of color filters is disposed between two adjacent data lines of the plurality of data lines;
forming a plurality of black matrices on the substrate, wherein each black matrix of the plurality of black matrices is disposed between two adjacent color filters of the plurality of color filters, and wherein each black matrix of the plurality of color filters overlaps each data line of the plurality of data lines;
coating a photoresist composition on the plurality of color filters and the plurality of black matrices to form a sacrificial layer;
providing light to the sacrificial layer through a mask, wherein the mask comprises a transparent part disposed on the plurality of data lines, a blocking part disposed on the plurality of color filters, and a slit part disposed between the transparent part and the blocking part, wherein an intensity of the light provided through the slit part is smaller than an intensity of the light provided through the transparent part; and
hard-baking the sacrificial layer to form a sacrificial pattern, wherein the sacrificial pattern includes a flat area having a substantially flat surface and a stepped area having a stepped height adjacent to an edge of the flat area.

8. The method of claim 7, wherein the slit part comprises a slit and a gap, wherein the light is reflected from the slit and is transmitted through the gap, wherein the gap is interposed between the slit and the blocking part.

9. The method of claim 8, wherein a width of the gap is about 50% to about 80% of a width of the slit part, wherein the width of the slit part is a combined width of the gap and the slit.

10. The method of claim 9, wherein the width of the gap is within a range of about 1.3 μm to about 2.1 μm.

11. The method of claim 10, wherein the width of the slit part is within a range of about 2.6 μm to about 4.2 μm.

12. The method of claim 7, further comprising:
soft-baking the sacrificial layer prior to the providing of the light to the sacrificial layer.

13. The method of claim 12, wherein the sacrificial layer is soft-baked within a temperature range of about 120° C. to about 130° C.

14. The method of claim 7, wherein the sacrificial layer is hard-baked within a temperature range of about 130° C. to about 150° C.

15. The method of claim 7, further comprising:
forming a first electrode on the plurality of color filters; and
forming a second electrode on the sacrificial pattern.

16. The method of claim 7, further comprising:
replacing the sacrificial pattern with a liquid crystal layer, wherein the liquid crystal layer fills a space occupied by the sacrificial pattern.

17. The method of claim 16, wherein the replacing of the sacrificial pattern comprises:
depositing an inorganic material on the second electrode to form an insulating layer,
forming a roof layer on the insulating layer,
removing the sacrificial pattern by using a developer,
injecting a liquid crystal into the space occupied by the sacrificial pattern to form the liquid crystal layer.

18. A method of manufacturing a display panel comprising:
forming a first color filter and a second color filter on a substrate;
forming a first electrode and a second electrode on the first color filter and the second color filter, respectively;
forming a black matrix between the first color filter and the second color filter;
forming a sacrificial layer on the first color filter, the second color filter and the black matrix;
patterning the sacrificial layer to form a preliminary first sacrificial pattern on the first color filter and a preliminary second sacrificial pattern on the second color filter by removing a portion of the sacrificial layer disposed between the first color filter and the second color filter,
wherein the preliminary first sacrificial pattern includes a first flat region and a first stepped region, wherein the preliminary second sacrificial pattern includes a second flat region and a second stepped region, wherein the first stepped region and the second stepped region face each other across the black matrix disposed between the first stepped region and the second stepped region and wherein the first flat region and the second flat region include substantially flat surface; and
baking the preliminary first sacrificial pattern and the preliminary second sacrificial pattern to form a first sacrificial pattern and a second sacrificial pattern.

19. The method of claim 18, wherein the baking of the preliminary first sacrificial pattern and the preliminary second sacrificial pattern is performed at a temperature range of about 130° C. to about 150° C.

20. The method of claim 18, wherein the patterning of the sacrificial layer includes providing light to the sacrificial layer through a mask, wherein the mask comprises a transparent part disposed on the portion of the sacrificial layer between the first color filter and the second color filter, a blocking part disposed on the first color filter and the second color filter, and a slit part disposed between the transparent part and the blocking part, wherein an intensity of light provided through the slit part is smaller than an intensity of light provided through the transparent part.
